(19) United States
(12) Patent Application Publication
(10) Pub. No.: US 2025/0121395 A1
(43) Pub. Date: Apr. 17, 2025

(54) CLEANING DEVICE FOR AN ELECTRODE ASSEMBLY OF AN ATOMIZER

(71) Applicant: Dürr Systems AG, Bietigheim-Bissingen (DE)

(72) Inventors: Sandra Berndt, Ditzingen (DE); Thomas Buck, Sachsenheim (DE); Manfred Michelfelder, Steinheim (DE)

(21) Appl. No.: 18/683,785

(22) PCT Filed: Aug. 1, 2022
(86) PCT No.: PCT/EP2022/071518

§ 371 Date: Feb. 15, 2024

(30) Foreign Application Priority Data
Aug. 19, 2021 (DE) 10 2021 121 552.8

(51) Int. Cl. B05B 15/555; B05B 5/053; F26B 3/02

(52) U.S. Cl. CPC B05B 15/555; B05B 5/0533; F26B 3/02

(57) ABSTRACT

The disclosure relates to a cleaning device for cleaning an electrode assembly having a plurality of finger-shaped external electrodes for electrostatic external charging on an atomizer, in particular on a rotary atomizer. The cleaning device has a first cleaning chamber with an insertion opening for receiving one of the finger-shaped external electrodes of the electrode assembly during a cleaning process. The disclosure provides at least a second cleaning chamber having an insertion opening for receiving one of the finger-shaped external electrodes of the electrode assembly during the cleaning process, so that at least two of the finger-shaped external electrodes of the electrode assembly can be cleaned simultaneously during the cleaning process. Furthermore, the disclosure comprises a corresponding operating method for such a cleaning device.

### CROSS-REFERENCE TO RELATED APPLICATIONS

This application is a national stage of, and claims priority to, Patent Cooperation Treaty Application No. PCT/EP2022/071518, filed on Aug. 1, 2022, which application claims priority to German Application No. DE 10 2021 121 552.8, filed on Aug. 19, 2021, which applications are hereby incorporated herein by reference in their entireties.

### FIELD

The disclosure relates to a cleaning device for cleaning an electrode assembly with several finger-shaped external electrodes (“finger electrodes”) for electrostatic external charging on an atomizer (e.g. rotary atomizer). Furthermore, the disclosure relates to a corresponding operating method for such a cleaning device. Furthermore, the disclosure also relates to a correspondingly adapted electrode assembly for electrostatic external charging on an atomizer (e.g. rotary atomizer).

### BACKGROUND

In modern painting installations for painting vehicle body components, rotary atomizers moved by a multi-axis painting robot are usually used as application device. To increase the application efficiency (ratio of the amount of paint deposited on the vehicle body components to the amount of paint sprayed off) or to reduce the disturbing overspray, electrostatic paint charging is usually used, i.e. the applied paint is electrostatically charged, whereas the vehicle body components to be painted are electrically grounded, so that the electrostatically charged paint is deposited mainly on the electrically grounded vehicle body components, which is desirable. In one variant of this electrostatic paint charging, finger-shaped external electrodes are used which project obliquely forwards and outwards from the atomizer housing of the rotary atomizer and electrostatically charge the spray jet of paint emitted by the rotary atomizer. The problem here is that the paint can also be deposited on the finger-shaped external electrodes, which is undesirable because this leads to high-voltage interference and thus to interruption of the painting process. It is therefore known from the prior art to clean the finger-shaped external electrodes of such an electrode assembly. For this purpose, the individual finger-shaped external electrodes can be inserted one after the other into a cleaning device in which the external electrodes are cleaned with a cleaning fluid (e.g. rinsing fluid, mixture of air and rinsing fluid).

A disadvantage here is the fact that the individual finger-shaped external electrodes can only be cleaned one after the other, so that the time required to clean the electrode assembly is relatively long.

Another disadvantage of the known cleaning devices is that the painting robot must be programmed so that the finger-shaped external electrodes are inserted exactly into the cleaning device. The motion sequence required for this is relatively complicated, so that the programming of the robot motion for a cleaning process is also correspondingly complex.

For the technical background of the disclosure, reference should also be made to DE 101 10 098 A1, WO 2020/021 109 A1 and DE 10 2019 135 360 A1.

### BRIEF DESCRIPTION OF THE DRAWINGS

FIG. 1 shows a perspective view of a cleaning device according to the disclosure with two cleaning modules, each with two cleaning chambers.

FIG. 2 shows a side view of the cleaning device from FIG. 1.

FIG. 3 shows a perspective view of a modified embodiment of a cleaning device.

FIG. 4 shows a top view of the cleaning device from FIG. 3.

FIG. 5 shows a perspective view of a rotary atomizer with an electrode assembly inserted into a module of the cleaning device.

FIG. 6 shows a cutaway perspective view corresponding to FIG. 5.

FIG. 7 shows a side view of the cleaning device according to FIGS. 3-6.

FIG. 8 shows a side view of a cleaning device according to the disclosure with a spring suspension.

FIG. 9 shows a cut-away perspective view of a cleaning chamber of a cleaning device according to the disclosure.

FIG. 10 shows a cut-away side view of a cleaning chamber of a cleaning device according to the disclosure.

FIG. 11 shows a side view with two possible positions of a rotary atomizer during a cleaning process.

FIG. 12 shows a side view of a cleaning device in which the rotary atomizer must assume a certain position during a cleaning process.

FIG. 13 shows a flow diagram to illustrate the operating procedure according to the disclosure.

FIG. 14 shows a schematic representation of a cleaning device according to the disclosure.

### DETAILED DESCRIPTION

The disclosure is based on the task of creating a correspondingly improved cleaning device for an electrode assembly of an atomizer. Furthermore, the disclosure is based on the task of specifying a corresponding operating method for such a cleaning device. Furthermore, the disclosure is based on the task of creating a suitable electrode assembly for electrostatic external charging.

First of all, in accordance with known cleaning devices, the cleaning device according to the disclosure comprises a first cleaning chamber having an insertion opening for receiving one of the finger-shaped external electrodes of the electrode assembly during a cleaning process, as already described above with respect to the prior art.

The cleaning device according to the disclosure is characterized in that not only a single cleaning chamber is provided, but at least a second cleaning chamber with an insertion opening for receiving one of the finger-shaped external electrodes during the cleaning process, so that at least two of the finger-shaped external electrodes of the electrode assembly can be cleaned simultaneously during the cleaning process.

Thus, the cleaning device according to the disclosure has at least two cleaning chambers for the individual finger-shaped external electrodes, so that a corresponding number of finger-shaped external electrodes of the electrode assembly can be cleaned simultaneously. This reduces the time required for a cleaning process accordingly. For example, the cleaning device according to the disclosure may have at least two, three, four, five, six, seven or even eight cleaning chambers.

In a preferred embodiment of the disclosure, the cleaning chambers of the cleaning device according to the disclosure are all aligned parallel to each other with respect to their insertion direction. This is particularly advantageous if the electrode assembly to be cleaned has finger-shaped external electrodes which are also aligned parallel to one another at least with their free ends. The finger-shaped external electrodes of the electrode assembly can then be inserted simultaneously into the associated cleaning chambers.

In the preferred embodiment of the disclosure, a seal is provided at the insertion opening of each of the individual cleaning chambers to prevent cleaning fluid (e.g., rinsing liquid, mixture of rinsing liquid and air) from escaping from the cleaning chamber during a cleaning process, which could lead to contamination of the surroundings. With regard to the constructive design of this seal, various possibilities exist within the scope of the disclosure.

One possibility of the constructive realization of the sealing provides for a contacting sealing, whereby it can be, for example, an annular sealing lip which annularly surrounds the external electrode to be cleaned during the cleaning process and rests on the outside against the outer surface of the external electrode to be cleaned, and preferably with a certain contact pressure.

Another way of structurally realizing the sealing of the insertion opening is a contactless sealing, for example in the form of a blow air ring which blows an air curtain across the insertion opening, as is known per se from the prior art.

The actual cleaning of the finger-shaped external electrodes of the electrode assembly then takes place within the individual cleaning chambers. For this purpose, spray nozzles can be arranged in the cleaning chambers to spray the finger-shaped external electrodes with the respective cleaning fluid during a cleaning process.

In the preferred embodiment of the disclosure, different types of spray nozzles are arranged in each of the cleaning chambers. A first spray nozzle is preferably used to spray the outer surface of the finger-shaped external electrodes with the cleaning fluid during the cleaning process. A second spray nozzle, on the other hand, is preferably used to spray the free end of the external electrode (i.e. the end face) with the cleaning fluid in the axial direction during the cleaning process. If the finger-shaped external electrodes to be cleaned are inserted into the cleaning chamber from above downwards, this second spray nozzle is preferably located below the external electrode to be cleaned.

The first spray nozzle for spraying the lateral surface of the finger-shaped external electrodes is preferably arranged in the respective cleaning chamber on the upper side near the insertion opening, for example in the upper quarter or upper fifth of the cleaning chamber.

Furthermore, it should be mentioned that the first spray nozzle for spraying the lateral surface of the finger-shaped external electrodes is preferably radially aligned in cross-section at right angles to the center axis of the respective cleaning chamber.

It should also be mentioned that the first spray nozzle for spraying the outer surface of the fin-shaped external electrodes is preferably inclined away from the respective insertion opening of the cleaning chamber, in particular at an angle to the central axis of the cleaning chamber of 0°-60°, 5°-50° or 10°-30°. This inclination of the first spray nozzle is useful so that, if possible, no cleaning fluid can escape from the insertion opening.

For example, the first spray nozzle for spraying the outer surface of the finger-shaped external electrodes can be designed as a flat jet nozzle that emits a flat jet of the cleaning fluid. Alternatively, however, it is also possible for the first spray nozzle for spraying the outer surface of the finger-shaped external electrodes to be designed as a full cone jet nozzle which emits a cone-shaped symmetrical jet of the cleaning fluid. Furthermore, it is possible that the at least one first spray nozzle is a rotating nozzle.

The second spray nozzle for spraying the front surface of the finger-shaped external electrodes is preferably arranged at the bottom side in the respective cleaning chamber, so that the second spray nozzle is located below the external electrode to be cleaned during the cleaning process.

The second spray nozzle for spraying the end face of the finger-shaped external electrode can thus be arranged centrally in the respective cleaning chamber.

In this case, the second spray nozzle can be aligned parallel to the center axis of the respective cleaning chamber and spray the cleaning fluid along the center axis of the respective cleaning chamber upwards in the direction of the external electrode to be cleaned.

In the preferred embodiment of the disclosure, at least one drying nozzle is preferably arranged in the individual cleaning chambers in order to blow compressed air onto the external electrode to be cleaned after the cleaning process and thereby dry it. The drying nozzle preferably blows the compressed air downward at an angle to the center axis of the respective cleaning chamber in order to strip off cleaning fluid adhering to the external electrode to be cleaned.

For example, this drying nozzle can be designed as an annular slot nozzle that blows an air curtain against the external electrode to be dried. Alternatively, however, it is also possible for the drying nozzle to consist of several individual nozzles which are distributed annularly around the circumference of the respective cleaning chamber and blow the compressed air inwards against the finger-shaped external electrode to be dried.

With regard to the drying nozzle, it should be mentioned that drying does not necessarily take place by blowing with compressed air. Rather, it is also possible that the drying nozzle is designed as a suction nozzle and sucks off air or a mixture of air, paint and/or rinsing agent to effect the drying.

In the preferred embodiment of the disclosure, the cleaning chambers are distributed over several cleaning modules, each containing several cleaning chambers. For example, a first cleaning module may have two cleaning chambers arranged in a row, wherein the two cleaning chambers in the first cleaning module are preferably aligned in parallel. A second cleaning module preferably also has at least two cleaning chambers arranged in a row, which are preferably also aligned in parallel with one another. The two cleaning modules are preferably aligned parallel to each other, so that the rows of cleaning chambers in the two cleaning modules run parallel to each other.

In the preferred embodiment of the disclosure, the cleaning modules are arranged opposite each other so that the cleaning chambers are all aligned in parallel. Here, the opposing cleaning modules may include a space therebetween to accommodate an atomizer while a plurality of the external electrodes mounted on the atomizer are inserted into the cleaning chambers. Thus, the atomizer (e.g., rotary atomizer) can be immersed with its atomizer housing in the space between the two opposing cleaning modules, with the finger-shaped external electrodes of the electrode assembly being inserted into the individual cleaning chambers of the cleaning modules.

The cleaning liquid is preferably supplied by a cleaning agent supply system. In addition, the cleaning device according to the disclosure preferably has a compressed air supply to feed in compressed air, which is also used in a cleaning process. A mixture of the cleaning liquid and the compressed air can then be sprayed off via a spray nozzle in order to clean the finger-shaped external electrodes. A valve arrangement can be provided here, which is connected on the input side to the cleaning agent supply and to the compressed air supply and on the output side to the at least one spray nozzle. The valve arrangement can assume different valve positions which serve different functions. In a mixing position, the valve arrangement can mix the compressed air with the cleaning liquid and pass the mixture to the spray nozzle. In a drying position, on the other hand, the valve arrangement selects only the compressed air and passes it on to the spray nozzle without the cleaning liquid for drying the external electrodes.

The individual cleaning chambers can be connected on the outlet side to a separating device which receives media (e.g. paint residues, rinsing liquid, compressed air) from the cleaning chamber and separates liquid media (e.g. rinsing liquid) from gaseous media (e.g. compressed air).

Such a separating device can be connected on the outlet side with a disposal system (e.g. collecting container), which receives liquid media from the cleaning chamber.

A controllable valve (e.g. ball valve) can be arranged between the separating device and the disposal system (e.g. collecting container), which controls the outflow from the separating device into the collecting container.

Furthermore, it is possible within the scope of the disclosure for the separating device to be open on the outlet side and to open, for example, into a funnel arranged below the separating device.

With regard to the assignment of the separating device to the cleaning chambers, various possibilities exist within the scope of the disclosure, which are briefly described below. In one variant of the disclosure, each of the cleaning chambers has its own separating device, which disposes of liquid media in its own disposal system. In another variant of the disclosure, the cleaning chambers each have their own separating device, but the liquid media are disposed of in a common disposal system. Finally, there is also the alternative possibility that the cleaning chambers have a common separating device which disposes of liquid media in a common disposal system.

It has already been mentioned above that spray nozzles may be provided in the cleaning chambers to spray the external electrodes with a cleaning fluid. In a preferred embodiment of the disclosure, several such spray nozzles are provided, which are supplied with the cleaning fluid from a common distribution ring. In this case, it is advantageous if the distributor ring is designed in such a way that the cleaning fluid runs out of the distributor ring automatically after a cleaning process. This is advantageous because no cleaning fluid remains in the distributor ring that could dry or drip out.

In the preferred embodiment of the disclosure, the cleaning device has a spring suspension with at least one spring for spring mounting of the cleaning device on a base. This is advantageous for cushioning collisions between the electrode assembly to be cleaned on the one hand and the cleaning device on the other hand. The spring suspension thus allows the spring-mounted cleaning device to move out of the way in the event of a collision, largely preventing damage to the electrode assembly and the cleaning device. In addition, the spring suspension also serves to provide a secure seal in order to maintain the pressure on the sealing points.

Only the cleaning of the individual finger-shaped external electrodes of the electrode assembly has been described above. In addition, there is also a need to clean the atomizer or atomizer housing. For this purpose, in addition to the cleaning chambers described above for the individual finger-shaped external electrodes, a separate cleaning chamber can be provided into which the atomizer can be inserted in order to clean the atomizer therein. The cleaning device for the finger-shaped external electrodes of the electrode assembly can here be built around the cleaning device for the atomizer housing.

The cleaning chamber for cleaning the finger-shaped external electrodes is preferably arranged substantially centrally in the cleaning device, so that the atomizer can insert its external electrodes into the cleaning chamber from opposite sides of the cleaning device. On the other hand, if the cleaning chamber is arranged very off-center, the atomizer must be positioned on the side of the cleaning device closer to the off-center cleaning chamber for cleaning its external electrodes.

Furthermore, it should be mentioned that the cleaning chamber preferably has a wall that is liquid-tight and/or air-tight.

The parallel ends of the external electrodes of the electrode assembly to be cleaned are preferably at least 1 cm, 2 cm or 3 cm long. This parallel alignment of the finger-shaped external electrodes is advantageous because the finger-shaped external electrodes can then be inserted together into the respective cleaning chambers of the cleaning device as part of a single linear movement.

Furthermore, it has already been briefly mentioned above that the cleaning fluid can be a mixture of compressed air and a cleaning liquid. The concentration of the cleaning fluid in this mixture can be adjusted depending on the degree of contamination of the finger-shaped external electrodes, as will be described in detail later. Cleaning is not limited to spraying. Cleaning could also be done dry or with brushes dry or wet or by means of textile fabric dry or wet.

In one embodiment of the disclosure, the cleaning chambers are arranged together on a rotating mechanism which is rotatable about an axis of rotation between different rotational positions, the cleaning chambers preferably being aligned parallel to the axis of rotation, and in each of the rotational positions a plurality of finger-shaped external electrodes can be cleaned simultaneously. For example, the electrode assembly to be cleaned may have eight finger-shaped external electrodes. The cleaning device can then have, for example, four cleaning chambers arranged on the rotating mechanism. This means that four finger-shaped external electrodes can be cleaned at the same time. To clean the other four finger-shaped external electrodes, the rotating mechanism only has to be turned slightly so that the cleaning chambers are aligned in the extension of the other finger-shaped external electrodes. The finger-shaped external electrodes can be inserted or withdrawn from the cleaning chambers by the coating robot, for example, or by a separate lifting mechanism that raises or lowers the cleaning chambers.

In addition to the cleaning device according to the disclosure described above, the disclosure also comprises a corresponding operating method. The operating method according to the disclosure is characterized by the fact that several external electrodes are inserted into the associated cleaning chambers of the cleaning device and then cleaned simultaneously.

Different types of spray nozzles can be arranged in the individual cleaning chambers to spray the outer surface or the front surface of the finger-shaped external electrode with a cleaning fluid.

Furthermore, it should be mentioned that the spray nozzles of the individual cleaning chambers can be controlled together and then deliver the cleaning fluid simultaneously. Alternatively, the cleaning processes in the various cleaning chambers can also be temporally offset. For this purpose, the spray nozzles in the individual cleaning chambers are controlled independently of one another and one after the other.

It should also be mentioned that the spraying of the outer surface and the spraying of the front surface of the finger-shaped external electrodes can be carried out either simultaneously or one after the other.

The disclosure also optionally allows the cleaning process to be adapted to the degree of contamination of the individual finger-shaped external electrodes. If, for example, the external electrodes are very heavily contaminated, a correspondingly intensive cleaning process is required. If, on the other hand, the external electrodes are only slightly contaminated, a correspondingly gentle cleaning process is sufficient. The disclosure therefore preferably provides that the degree of contamination of the individual finger-shaped external electrodes is determined, which can be done, for example, as part of a visual inspection by an operator or automatically by means of a measuring device. However, it is also possible to determine the degree of contamination by evaluating variables (e.g. current, voltage) of an electrostatic coating agent charge. Software can then determine the optimum cleaning time depending on the degree of contamination determined. The cleaning fluid is then adjusted as a function of the determined degree of contamination. For example, the concentration of the rinsing liquid in the cleaning fluid can be adjusted for this purpose. In the case of heavy contamination, a relatively high concentration of the rinsing fluid is then selected in order to achieve a correspondingly good cleaning effect. Furthermore, the amount of cleaning fluid delivered during a cleaning process can be adjusted depending on the degree of contamination, or the spray pressure with which the cleaning fluid is sprayed.

In addition to the cleaning device described above and the associated operating method also described above, the disclosure also claims protection for a correspondingly adapted electrode assembly for the electrostatic external charging of coating agent (e.g. paint).

The electrode assembly according to the disclosure has, in accordance with the known electrode assemblies for electrostatic external charging on an atomizer described at the outset, a plurality of finger-shaped external electrodes which serve to electrostatically charge the sprayed coating agent (e.g. paint).

The electrode assembly according to the disclosure is characterized by the fact that the finger-shaped external electrodes are aligned parallel to each other, at least at their ends. This is advantageous because the parallel external electrodes can then be introduced together into several cleaning chambers aligned parallel to one another.

It should be mentioned here that the finger-shaped external electrodes are not necessarily aligned parallel to each other along their entire length. Rather, it is also possible that the finger-shaped external electrodes are aligned parallel to each other only with their ends.

In a preferred embodiment of the disclosure, the electrode assembly has an annular mounting ring for mounting on the atomizer. The annular mounting ring can then, for example, simply be plugged onto the atomizer housing of a rotary atomizer, whereby the electrode assembly can then be fixed to the atomizer in the plugged-on state.

Furthermore, it should be mentioned that the finger-shaped external electrodes are preferably distributed over the circumference of the annular electrode assembly, the arrangement of the individual finger-shaped external electrodes preferably being equidistant.

The individual finger-shaped external electrodes can then be aligned with their parallel ends preferably at right angles to the mounting ring.

Furthermore, it should also be mentioned that the finger-shaped external electrodes can each have a sheathing made of an electrically insulating material (e.g. plastic), whereby the actual electrode tips are inserted into the sheathing and can project axially from the sheathing.

Furthermore, it should be mentioned that the electrode assembly according to the disclosure is preferably interchangeable. This made it possible to exchange different electrode assemblies for different application situations. For example, an electrode assembly for exterior painting can be exchanged for an electrode assembly for interior painting. In addition, the electrode assembly for electrostatic external charging can also be replaced by a cover (dummy) if painting is to be carried out without an electrostatic coating agent charge. Furthermore, a universal charging ring can alternatively be mounted, which serves for both interior painting and exterior painting.

Finally, the disclosure also claims protection for an atomizer (e.g. rotary atomizer) with such an electrode assembly according to the disclosure.

Other advantageous further embodiments of the disclosure are indicated in the dependent claims or are explained in more detail below together with the description of the preferred embodiments of the disclosure with reference to the figures.

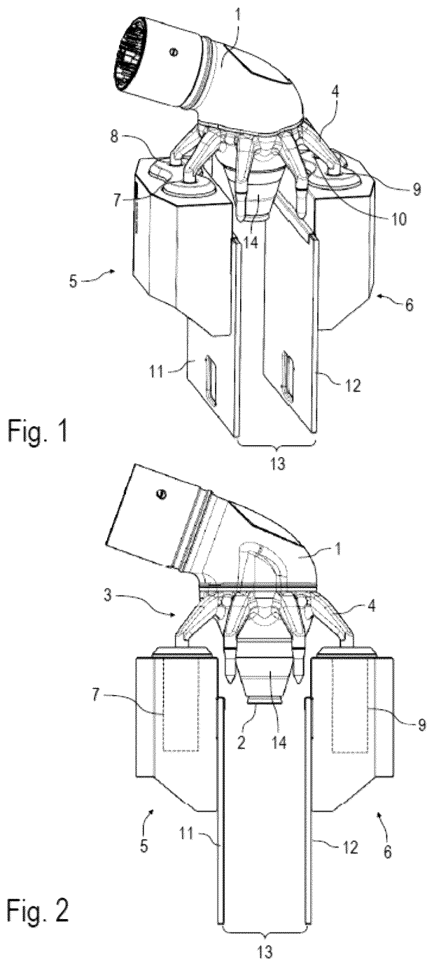

In the following, we will first describe an embodiment of a cleaning device according to the disclosure, as shown in FIGS. 1 and 2.

The drawings show a rotary atomizer 1 which is moved by a painting robot, whereby the painting robot is not shown in the drawing. The rotary atomizer 1 has a bell cup 2 as an application element, which rotates at high speed during operation, as is known from the prior art. The rotary atomizer 1 carries a removable electrode assembly 3 for electrostatic external charging of the sprayed paint, the electrode assembly 3 having a total of eight finger electrodes 4 which are distributed equidistantly over the circumference of the electrode assembly 3 and have parallel ends.

In this embodiment, the cleaning device according to the disclosure comprises two cleaning modules 5, 6, each of which contains two cleaning chambers 7, 8 and 9, 10, respectively. Thus, in the cleaning module 5, two of the finger electrodes 4 can be cleaned simultaneously. Correspondingly, two of the finger electrodes 4 can also be cleaned simultaneously in the other cleaning module 6.

The two cleaning modules 5, 6 are each mounted on the outside of a vertical mounting plate 11, 12, the two mounting plates 11, 12 enclosing an intermediate space 13. During a cleaning process, the rotary atomizer 1 with its atomizer housing 14 can dive into the intermediate space 13 between the two cleaning modules 5, 6, whereby the finger electrodes 4 are inserted into the associated cleaning chambers 7-10.

In this embodiment, four of the eight finger electrodes 4 can be cleaned simultaneously during a cleaning process. To clean the other four finger electrodes 4 of the electrode assembly 3, the rotary atomizer 1 must be repositioned accordingly by the painting robot. In contrast to the conventional cleaning device described at the beginning, however, only two cleaning processes are required, whereas eight cleaning processes would be necessary in the conventional cleaning device described at the beginning.

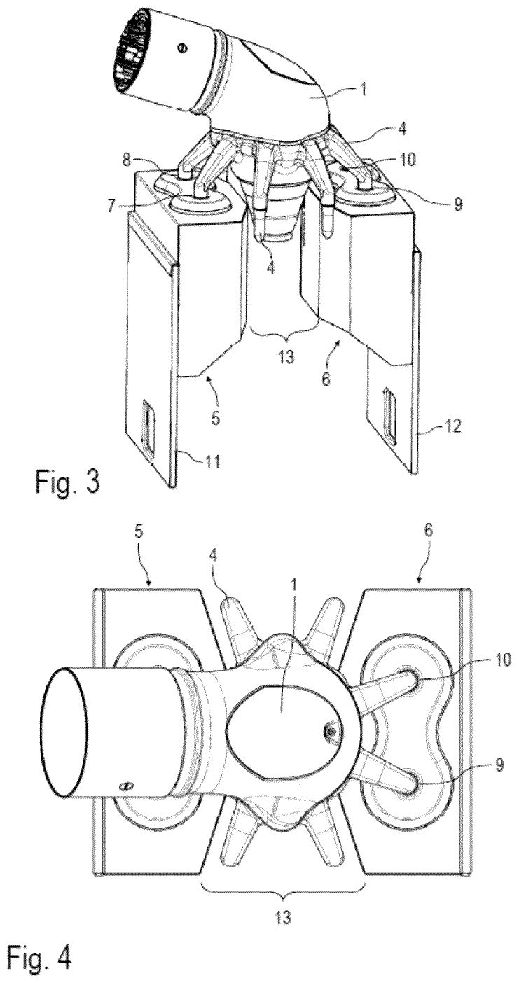

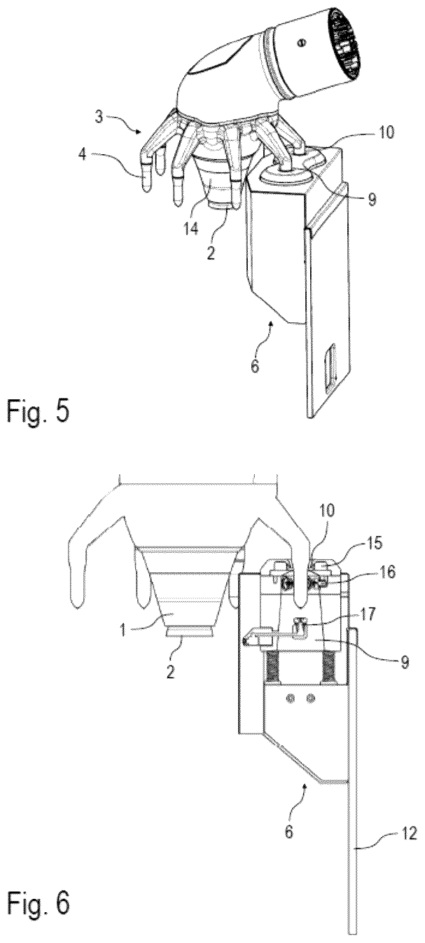

FIGS. 3-6 show a modified embodiment of a cleaning device according to the disclosure, which largely corresponds to the cleaning device described above and shown in FIGS. 1 and 2, so that reference is made to the above description in order to avoid repetition, the same reference signs being used for corresponding details.

A special feature of this embodiment is that the two cleaning modules 5, 6 are not mounted on the outside of the two mounting plates 11, 12, but on the inside of the two mounting plates 11, 12.

FIG. 6 further shows that a blow air ring 15 is arranged in the cleaning chamber 9 on the upper side near the insertion opening, which blows an air curtain transversely to the insertion opening and thereby prevents cleaning agents or paint residues from escaping from the cleaning chamber 9 during a cleaning process. The blow air ring 15 thus forms a non-contact seal of the insertion opening of the cleaning chamber 9.

Furthermore, it can be seen from the drawing that several spray nozzles 16 are arranged in the cleaning chamber 9 distributed over the circumference, which in this embodiment are designed as a flat spray nozzle and spray the outer lateral surface of the finger electrodes 4 with a cleaning fluid.

Furthermore, it can also be seen from the drawing that a spray nozzle 17 is arranged centrally on the underside of the cleaning chamber 9, which is aligned axially upwards and sprays the lower end face of the finger electrodes 4 with cleaning fluid.

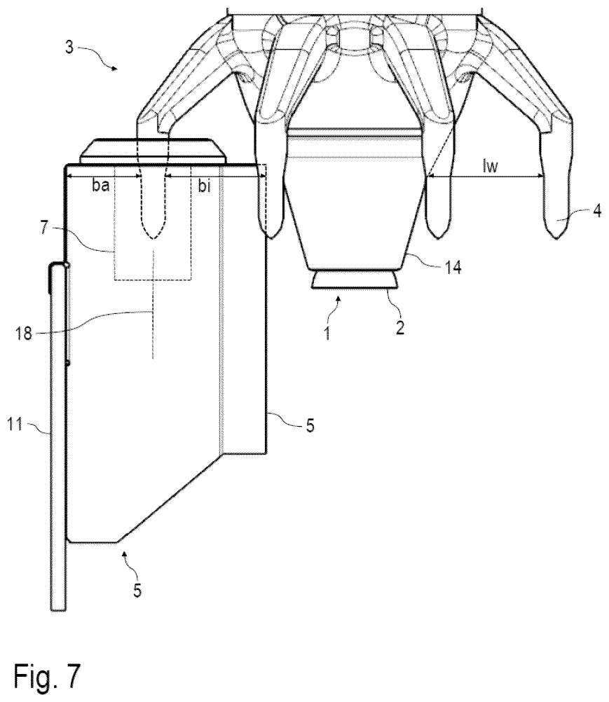

FIG. 7 shows the positioning of the rotary atomizer 1 during a cleaning process. For this purpose, the rotary atomizer 1 is moved from top to bottom so that the finger electrodes 4 to be cleaned are immersed in the respective cleaning chamber 7. It should be mentioned here that the cleaning chamber 7 is arranged essentially centrally in the cleaning module 5. This means that between the central axis 18 of the cleaning chamber 7 and the lateral outer contour of the cleaning module 6 there is a distance ba and bi, respectively, the two distances ba, bi being approximately equal.

Furthermore, it should be mentioned that the rotary atomizer 1 has a clear width lw between the outer contour of the atomizer housing 14 and the finger electrodes 4 which is greater than the distances ba, bi. This is advantageous because the rotary atomizer 1 can thus be positioned not only—as shown—on the right side of the cleaning module 5. Alternatively, it is also possible to position the rotary atomizer 1 to the left of the cleaning module 5 during a cleaning process.

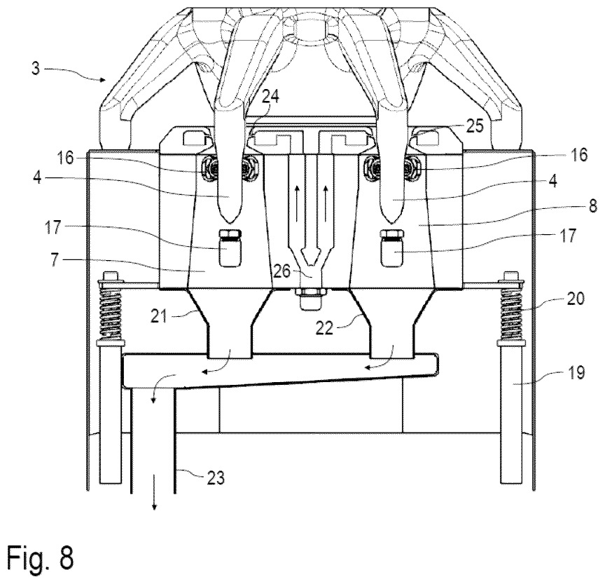

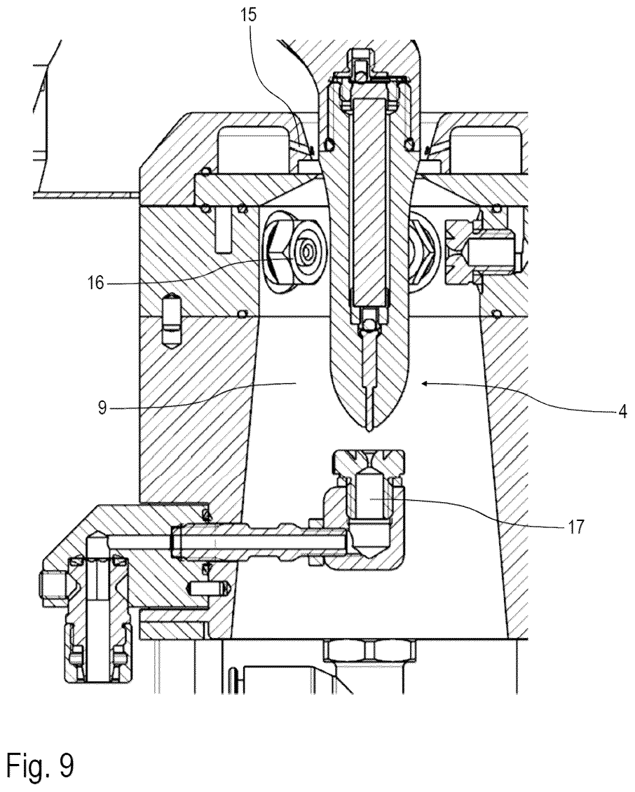

FIG. 8 shows a diagram illustrating the spring suspension of the cleaning device. The cleaning device is spring-suspended on a base 19 by means of spiral springs 20. The spring suspension of the cleaning device is particularly advantageous in the event of collisions between the rotary atomizer 1 or the electrode assembly 3 and the cleaning device, since the spiral springs 20 of the suspension allow the cleaning device to move out of the way, whereby damage to the electrode assembly 3 or the cleaning device can be largely prevented.

Furthermore, it can be seen from the illustration that discharge funnels 21, 22 are arranged on the underside of the two cleaning chambers 7, 8, which flow into a common disposal system 23. During a cleaning process, residues of paint, rinsing agent and compressed air can therefore be discharged through the discharge funnels 21, 22 into the common disposal system 23, as indicated by the arrows.

Furthermore, it can be seen from the drawing that blow air rings 24, 25 are supplied with compressed air from a common compressed air supply 26.

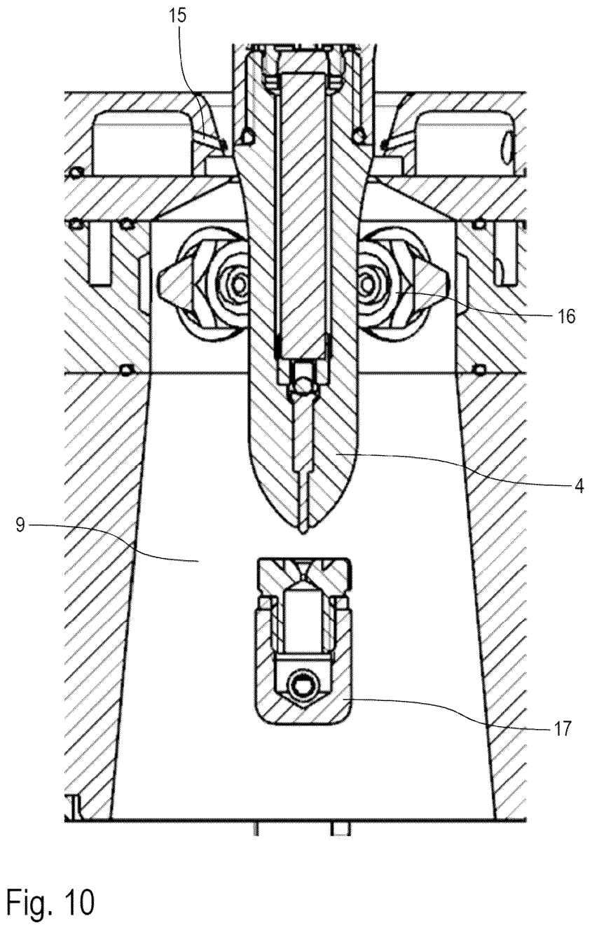

FIG. 10 shows a variation of the above-described embodiments, in which the spray nozzles 16 are designed as full cone spray nozzles.

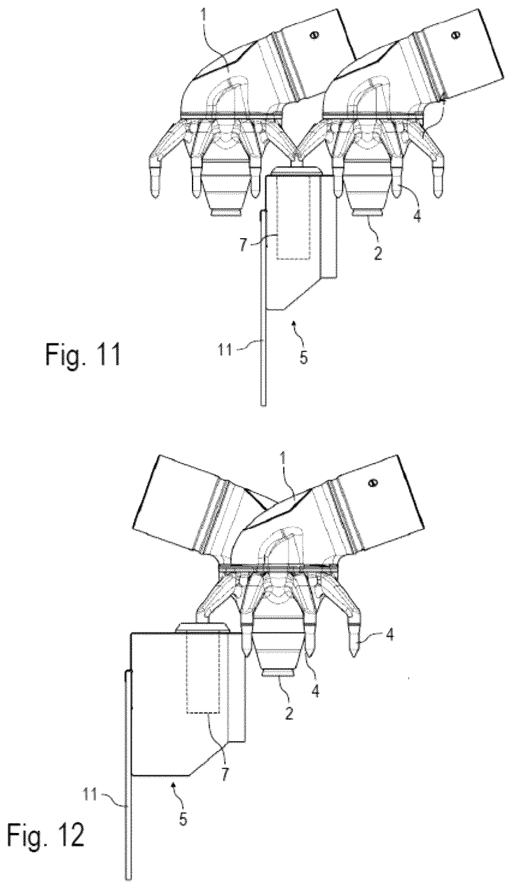

FIGS. 11 and 12 again show the positioning of the rotary atomizer 1 on the cleaning module 5. In the variant according to FIG. 11, the cleaning chamber 7 is arranged centrally, so that the rotary atomizer 1 can be positioned on either side as desired during the cleaning process. In the variant according to FIG. 12, on the other hand, the cleaning chamber 7 is arranged off-center so that the rotary atomizer 1 can only be positioned on the right-hand side in the drawing during a cleaning process, which necessitates time-consuming repositioning of the rotary atomizer 1 when cleaning the other finger electrodes 4.

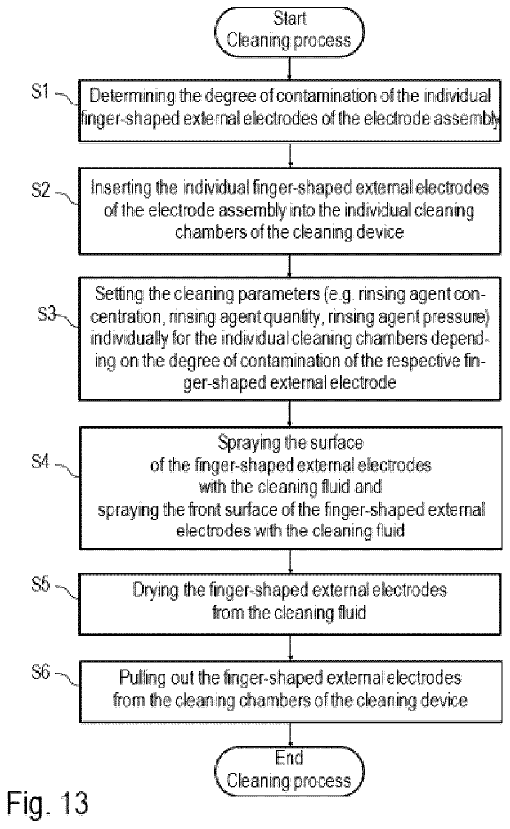

In the following, the flow chart according to FIG. 13 will now be described, which explains an example of the operating method according to the disclosure.

In a first step S1, the degree of contamination of the individual finger-shaped external electrodes (“finger electrodes”) of the electrode assembly is first determined. This can be done by an operator or automated by a measuring device.

In a next step S2, the finger-shaped external electrodes of the electrode assembly are then introduced into the individual cleaning chambers of the cleaning device.

In a further step S3, cleaning parameters are then set individually for the individual cleaning chambers depending on the degree of contamination of the respective finger-shaped external electrodes. For example, a high concentration of rinsing agent can then be used to clean a heavily contaminated finger-shaped external electrode. For cleaning an only slightly contaminated finger-shaped external electrode, on the other hand, a low concentration of rinsing agent can be used.

In the next step S4, the lateral surfaces and the end surfaces of the finger-shaped external electrodes are then sprayed with the cleaning fluid. This can be a mixture of cleaning fluid and compressed air, for example.

In the next step S5, the finger-shaped external electrodes can then be dried, for example by blowing on them with compressed air.

In the next step S6, the finger-shaped external electrodes are then pulled out of the cleaning chambers of the cleaning device.

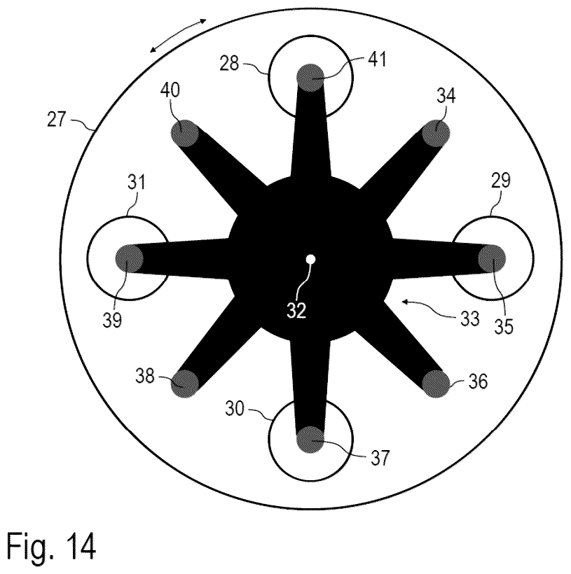

Finally, FIG. 14 shows a schematic representation of a cleaning device according to the disclosure with a rotary mechanism 27, wherein four cleaning chambers 28-31 are arranged on the rotary mechanism 27. The cleaning chambers 28-31 can be rotated about an axis of rotation 32 by the rotary mechanism 27.

Furthermore, an electrode assembly 33 is shown, which serves for electrostatic external charging and has eight finger electrodes 34-41. In the rotational position of the rotating mechanism 27 shown, the finger electrodes 35, 37, 39, 41 are located in the associated cleaning chambers 28, 29, 30, and 31, respectively, and can then be cleaned simultaneously. To clean the other finger electrodes 34, 36, 38, 40, the entire electrode assembly 33 must first be pulled out of the cleaning device. This can be done either by the cleaning robot or by a separate lifting mechanism. Subsequently, the rotating mechanism 27 is then rotated in the direction of the double arrow, whereupon the other finger electrodes 34, 36, 38, 40 can then be immersed in the cleaning chambers 28-31 to be cleaned therein.

The disclosure is not limited to the preferred embodiments described above. Rather, the disclosure also encompasses a variety of variations and modifications which also make use of the inventive concept and therefore fall within the scope of protection. In particular, the disclosure also claims protection for the subject-matter and the features of the dependent claims independently of the respective claims referred to and in particular also without the features of the main claim. The disclosure thus comprises various aspects of the disclosure which enjoy protection independently of one another.

1.-24. (canceled)

25. A cleaning device for cleaning an electrode assembly with several finger-shaped external electrodes for electrostatic external charging on an atomizer, comprising:
a) a first cleaning chamber with an insertion opening for receiving one of the finger-shaped external electrodes of the electrode assembly during a cleaning process, and
b) at least one second cleaning chamber with an insertion opening for receiving one of the finger-shaped external electrodes of the electrode assembly during the cleaning process, so that at least two of the finger-shaped external electrodes of the electrode assembly can be cleaned simultaneously during the cleaning process.

26. The cleaning device according to claim 25, wherein the cleaning chambers are all aligned parallel to each other to receive the parallel finger-shaped external electrodes of the electrode assembly.

27. The cleaning device according to claim 25, wherein a seal is provided at the insertion opening of each of the cleaning chambers, the seal preventing a cleaning fluid from escaping from the cleaning chamber during a cleaning process.

28. The cleaning device according to claim 27, wherein the seal at the insertion opening of the cleaning chambers is designed as a contacting seal.

29. The cleaning device according to claim 28, wherein the seal comprises an annular sealing lip which annularly surrounds the external electrode to be cleaned during the cleaning process and rests on the outside against the external electrode to be cleaned.

30. The cleaning device according to claim 27, wherein the seal is designed as a contactless seal.

31. The cleaning device according to claim 30, wherein the seal comprises a blown air ring which blows an air curtain across the insertion opening.

32. The cleaning device according to claim 25, wherein in at least one of the cleaning chambers at least one first spray nozzle is arranged to spray the outer surface of the finger-shaped external electrode with the cleaning fluid during the cleaning process.

33. The cleaning device according to claim 32, wherein at least one second spray nozzle is arranged in at least one of the cleaning chambers in order to spray the free end of the external electrode with the cleaning fluid in the axial direction during the cleaning process, in particular axially from the front with respect to the external electrode to be cleaned.

34. The cleaning device according to claim 32, wherein the at least one first spray nozzle is arranged in the respective cleaning chamber on the upper side near the insertion opening in the upper quarter or fifth of the cleaning chamber.

35. The cleaning device according to claim 34, wherein the first spray nozzle is radially aligned in cross-section at right angles to the central axis of the respective cleaning chamber.

36. The cleaning device according to claim 34, wherein the first spray nozzle is inclined away from the insertion opening of the respective cleaning chamber.

37. The cleaning device according to claim 34, wherein the first spray nozzle is designed as a flat jet nozzle which emits a flat jet of the cleaning fluid.

38. The cleaning device according to claim 34, wherein the first spray nozzle is designed as a full cone jet nozzle which emits a cone-shaped symmetrical jet of the cleaning fluid.

39. The cleaning device according to claim 33, wherein
a) the second spray nozzle is arranged in the respective cleaning chamber on the underside, so that the second spray nozzle is located under the external electrode to be cleaned during the cleaning process, and
b) the second spray nozzle is arranged centrally in the respective cleaning chamber, and
c) the second spray nozzle is aligned parallel to the central axis of the respective cleaning chamber and sprays the cleaning fluid upwards along the central axis of the respective cleaning chamber in the direction of the external electrode to be cleaned.

40. The cleaning device according to claim 25, wherein
a) a drying nozzle is arranged in at least one of the cleaning chambers in order to blow on or suck off the external electrode to be cleaned with compressed air after the cleaning process and thereby dry it,
b) the drying nozzle blows the compressed air downwards at an angle to the central axis of the respective cleaning chamber, in order to strip off cleaning fluid adhering to the external electrode to be cleaned downwards.

41. The cleaning device according to claim 40, wherein the drying nozzle is designed as an annularly circulating slot nozzle which blows an air curtain against the external electrode to be dried.

42. The cleaning device according to claim 40, wherein the drying nozzle is designed as a plurality of individual nozzles which are distributed annularly over the circumference of the respective cleaning chamber and blow the compressed air in each case inwards against the external electrode to be dried.

43. The cleaning device according to claim 25, further comprising
a) a first cleaning module with at least two cleaning chambers arranged in a row for receiving and cleaning an external electrode in each case, the two cleaning chambers in the first cleaning module being aligned in parallel, and
b) a second cleaning module having at least two cleaning chambers arranged in a row for receiving and cleaning in each case one external electrode, the two cleaning chambers being aligned in parallel in the second cleaning module,
c) wherein the cleaning modules are aligned parallel to one another, so that the rows of the cleaning chambers in the two cleaning modules run parallel to one another.

44. The cleaning device according to claim 43, wherein
a) the two cleaning modules are arranged opposite each other so that the cleaning chambers are all aligned in parallel,
b) the two cleaning modules enclose a space therebetween for receiving an atomizer while a plurality of external electrodes mounted on the atomizer are inserted into the cleaning chambers.

45. The cleaning device according to claim 25, further comprising
a) a cleaning agent supply for supplying a cleaning liquid,
b) a compressed air supply for supplying compressed air,
c) at least one spray nozzle for spraying the finger-shaped external electrodes with a mixture of the cleaning liquid and the compressed air, and
d) a valve arrangement, the valve arrangement being connected on the inlet side to the cleaning agent supply and the compressed air supply and on the outlet side to the at least one spray nozzle,
e) wherein the valve arrangement has at least one of the following valve positions:
e1) a mixing position, in which the valve arrangement mixes the compressed air with the cleaning fluid and passes the mixture on to the spray nozzle,
e2) a drying position, in which the valve arrangement selects only the compressed air and passes it on to the spray nozzle without the cleaning liquid for drying the external electrode.

46. The cleaning device according to claim 25, wherein
a) at least one of the cleaning chambers is connected on the outlet side to a separating device which receives media from the cleaning chamber and separates liquid media from gaseous media, and
b) the separating device is connected on the outlet side to a disposal system, in particular to a collecting container which receives liquid media from the cleaning chamber, and
c) a controllable valve, is arranged between the separating device and the disposal system, which valve controls the outflow from the separating device into the collecting container, and
d) the separating device is open on the outlet side and opens into a funnel arranged below the separating device.

47. The cleaning device according to claim 46, wherein the individual cleaning chambers each have a separating device which disposes of liquid media into a separate disposal system in each case.

48. The cleaning device according to claim 46, wherein the individual cleaning chambers each have a separating device which disposes of liquid media in a common disposal system.

49. The cleaning device according to claim 46, wherein the cleaning chambers have a common separating device which disposes of liquid media in a common disposal system.

50. The cleaning device according to claim 25, wherein
a) several spray nozzles are provided to spray the external electrodes with a cleaning fluid,
b) the spray nozzles are supplied with the cleaning fluid from a common distributor ring, and
c) the distributor ring is designed in such a way that the cleaning fluid runs out of the distributor ring independently after a cleaning operation.

51. The cleaning device according to claim 25, wherein
a) the cleaning device has a spring suspension with a spring for the springy mounting of the cleaning device on a base, in particular for the prevention of collisions between the electrode assembly to be cleaned and the cleaning device, and
b) in addition to the cleaning chambers for cleaning the finger-shaped external electrodes, a separate cleaning chamber is provided for cleaning the atomizer, so that the external electrodes and the atomizer can be cleaned simultaneously, and
c) the cleaning chamber is arranged substantially centrally in the cleaning device so that the atomizer can insert its external electrodes into the cleaning chamber from opposite sides of the cleaning device, and
d) the cleaning chamber has a wall which is liquid-tight and/or air-tight, and
e) the parallel ends of the external electrodes are at least 1 cm long, and
f) the cleaning fluid is a mixture of compressed air and a cleaning liquid.

52. The cleaning device according to claim 25, wherein
a) the cleaning chambers are arranged together on a rotary mechanism which can be rotated about an axis of rotation between different rotary positions, the cleaning chambers being aligned parallel to the axis of rotation, and in each of the rotary positions in each case a plurality of finger-shaped external electrodes can be cleaned simultaneously,
b) a lifting mechanism is provided in order to lift the cleaning chambers together along the insertion direction and thereby to insert the finger-shaped external electrodes to be cleaned into the cleaning chambers or to remove them from the cleaning chambers.
